(19) United States
(12) Patent Application Publication
(10) Pub. No.: US 2010/0134420 A1
(43) Pub. Date: Jun. 3, 2010

(54) A KEYBOARD

(75) Inventor: Jesper Gluckstad, Frederiksberg (DK)

Correspondence Address: VOLENTINE & WHITT PLLC, ONE FREEDOM SQUARE, 11951 FREEDOM DRIVE SUITE 1260, RESTON, VA, 20190, US

(73) Assignee: DANMARKS TEKNISKE UNIVERSITET, Lyngby (DK)

(21) Appl. No.: 12/516,871

(22) PCT Filed: Nov. 30, 2007
(86) PCT No.: PCT/EP07/63097

§ 371 Date: Jan. 14, 2010

Related U.S. Application Data
(60) Provisional application No. 60/861,975, filed on Dec. 1, 2006.

(30) Foreign Application Priority Data
Dec. 1, 2006 (DK) PA 2006 01589

(51) Int. Cl. G06F 3/02

(52) U.S. Cl. 345/172

(57) ABSTRACT

The present invention relates to a keyboard with a plurality of keys with key switches that are covered by a flexible display for displaying individual labels of the keys whereby the label can be changed during operation of the keyboard by appropriate control of the keyboard. The flexible display is pre-shaped into a non-planar shape to fit on top of the key switches so that each key switch can be activated by depressing the area of the flexible display displaying the key label of the key switch in question. Each key may have a key cap with a transparent top surface with the flexible display mounted underneath the key cap for displaying the individual label of the key viewable through the transparent top surface of the key cap. The keyboard provides tactile feedback similar to a conventional high quality keyboard.

The present invention relates to a keyboard e.g. for use with a computer, an electronic game, a musical instrument, a money dispenser, a sales terminal, or another terminal, etc., having labels on the keys that can be changed during operation of the keyboard, e.g. in order to display symbols or icons in the labels that indicate the current functions of the respective keys of the keyboard.

Almost everything relating to today's personal computers are subject to ongoing significant developments. The ongoing development of processor power, the flat screens, and wireless interfaces are evident examples of this development. However, the computer keyboard seems to constitute an exception. The keyboard design has remained largely unchanged since the invention of the typewriter although a few differences from one language to another and a few functional keys arranged in proprietary layouts have been introduced.

Typically, a keyboard for a computer or the like has keys labeled with characters of the English written language. The labels are printed or molded in a predetermined arrangement in the following denoted the keyboard layout. Some European countries have a greater range of characters and vowels than the English language so that keyboards in some countries have some keys with different key positions.

It is an object of the present invention to provide a keyboard with an improved versatility.

According to the present invention, the above-mentioned and other objects are fulfilled by a keyboard with a plurality of keys with key switches that are covered by a flexible display for displaying individual labels of the keys, the flexible display being pre-shaped into a non-planar shape to fit on top of the key switches so that each key switch is activated by depressing the area of the flexible display displaying the key label of the key switch in question.

Thus, the keyboard has upper parts that are constituted by the flexible display for displaying individual labels of the keys.

In one embodiment of the invention, each of the keys with labels displayed by the flexible display has a key cap with a transparent top surface, and the flexible display is mounted underneath the key caps for displaying individual labels of the keys viewable through the transparent top surfaces of the respective key caps.

Preferably, each key has a top surface, such as a flat top surface, that does not or substantially does not change its shape when the key is depressed similar to a conventional keyboard with individually depressible keys.

Preferably, each key of the keyboard is displaced when pushed by the user of the keyboard, i.e. a key is depressed when activated by the user.

Preferably, each key switch of the plurality of keys has a substantially non-flexible member with a contact element, and the non-flexible member is arranged to be displaced when the corresponding key is depressed until contact between the contact element and an electric circuit of the keyboard is established. The non-flexible member may be biased with spring means away from its depressed position. The spring means may be a coil spring, a flat spring, a leaf spring, etc.

It is an advantage of the present invention that the keyboard is operated by a user in the same way as a conventional keyboard. For example, a specific type of tactile feed back experienced by the user during use of a particular conventional keyboard may also be provided by a keyboard according to the present invention. The tactile feed back relates to how it feels to depress a key of the keyboard, for example whether a “click” is generated by a key when depressed by the user and how the “click” feels and sounds. Tactile feed back also relates to the size of the linear displacement of the key when depressed by the user, etc.

Preferably, the key switch is neither a dome switch nor a membrane switch.

Further, the various key layouts provided by conventional keyboards may also be provided by the keyboard according to the present invention, for example the user may select a specific keyboard layout by activating respective specific keys of the keyboard either simultaneously and/or in a specific sequence.

In accordance with the invention, the keyboard is provided with a display for displaying the keyboard labels on the top surface of the keys thereby replacing the conventionally fixed key labels with labels that can be changed during operation of the keyboard by appropriate control of the keyboard.

Preferably, the display has the conventional display capabilities known from conventional liquid crystal displays, light emitting diode displays, or plasma displays, e.g. used in television or computer flat screens, making it possible to display almost anything on top of each key of the keyboard and to change whatever is currently displayed in the key label to something else during operation of the keyboard. In this way, key labels may also be animated according to the present invention.

Preferably, the displayed label of a key indicates the current function of the key. For example when the keyboard is used as a typewriter keyboard, the flexible display may display a conventional layout of lower case letters, numbers and other characters used in writing in the country in question. When depressing the “shift”-key, the display changes the labels into upper case letters, numbers, etc, and when depressing the “AltGr”-key, the display changes the labels accordingly. Thus, the user is relieved from the task of remembering which keys to depress in order to type specific graphical symbols. Likewise, when the keyboard is used together with a computer with a word processor utilizing various function keys, the keyboard may display symbols indicating the respective functions of the function keys executed by the word processor upon activation of the respective key. The functions may be changed during operation of the word processor. Preferably, the word processor allows the user to select an appropriate layout of the keyboard, e.g. various layouts of various countries may be selectable and the Dvorak layout may be selectable. Preferably, the word processor allows the user to specify the function of each key of the keyboard thereby creating an individual keyboard layout.

It is an important advantage of the keyboard according to the invention that the layout of the keyboard is easily changed from one alphabet to another and/or from the layout of one country to another. For example, the keyboard according to the invention may display layouts of the European, Japanese, Arabic, Russian, Chinese, etc., alphabet.

Preferably, the keyboard has a single display for displaying the labels of all keys of the keyboard; however the display may be divided into a plurality of separate display units.

Some of the keys of the keyboard may be conventional keys with fixed labels.

Preferably, the display resides on a flexible substrate that is shaped to fit onto a plurality of the key contacts to be depressed by the user during operation of the keyboard.

Several display technologies are presently available that may reside on a flexible substrate. For example, an organic light emitting diode (OLED) display may reside on a flexible substrate, such as a very flexible metallic foil, a flexible polymeric foil, etc. OLEDs can be printed onto flexible substrates in the same way as inks are sprayed onto paper during printing. Since OLEDs can be printed onto any suitable substrate using inkjet printer technology, they can theoretically have a significantly lower cost than LCDs or plasma displays.

An organic light-emitting diode (OLED) is a special type of light-emitting diode in which the emissive layer comprises a thin-film of certain organic compounds. Originally, small molecule organic light emitting diodes (SMOLED), i.e. small organic molecules that emit light when stimulated electrically, were used; however, today's OLEDs typically utilize large polymer molecules for light emission sometimes termed PLED (polymer light emitting diode). PLEDs have the major advantage of being solution processable, and can therefore be applied to substrates using techniques such as ink jet printing. Dendrimer technology may also be applied in OLEDs. Dendrimers is a class of molecules featuring a high degree of branching and which can be designed to offer specific performance characteristics. In particular, in display technologies, dendrimers can be applied to small molecules to give them some of the properties of polymer systems e.g. solution processability.

In a passive matrix OLED (PMOLED), the cathode and anode are arranged in strips perpendicular to each other. The intersections of the cathode and anode make up the pixels where light is emitted. External circuitry applies current to selected strips of anode and cathode, determining which pixels get turned on and which pixels remain off. Again, the brightness of each pixel is proportional to the amount of applied current. Presently, PMOLEDs are most efficient for text and icons and are best suited for small screens (2 to 3 inch screens) such as screens for cell phones, PDAs and MP3 players, etc.

In a Active-matrix OLED (AMOLED), the cathode and anode constitute full layers, but the anode layer overlays a thin film transistor (TFT) array that forms a matrix. The TFT array is the circuitry that determines which pixels get turned on to form an image. AMOLEDs consume less power than PMOLEDs because the TFT array requires less power than external circuitry, so they are efficient for large displays. AMOLEDs also have faster refresh rates suitable for video. Typically, AMOLEDs are use in computer monitors, large screen TVs and electronic signs or billboards.

One of the great benefits of an OLED display over the traditional LCD displays is that OLEDs do not require a backlight to function. This means that they draw far less power and, when powered from a battery, can operate longer on the same charge. It is also known that OLED based display devices can be more effectively manufactured than liquid-crystal and plasma displays.

OLED technology is currently used in commercial applications such as small screens for mobile phones and portable digital music players (MP3 players), car radios and digital cameras and also in high resolution micro-displays for head-mounted displays.

Such portable applications favor the high light output of OLEDs for readability in sunlight, combined with their low power drain.

Electrophoretic displays, electro-wetting displays, polymer LCD displays, etc. are other examples of display technologies that may also reside on a flexible substrate.

The display may provide a conventional dot matrix arrangement below each of the transparent key caps.

In accordance with the present invention, the keyboard may be capable of representing every character, number and other symbols of every written language.

Further, the keyboard can also display an indication of the function of function keys used in connection with games and other software programs.

For example, the keyboard may sequentially display certain key labels in a way that guides the user through a certain software program thereby eliminating the need of consulting a manual for the program.

Further, the keyboard may display key labels corresponding to frequently used functions of a word processor, spreadsheet, database, CAD/CAM, etc., thereby facilitating the use of the word processor, spreadsheet, database, CAD/CAM, respectively.

Still further, the label display flexibility of the keyboard according to the present invention may be used to reduce the number of keys in a keyboard for e.g. a mobile phone, a PDA computer, or other portable equipment.

The keyboard according to the present invention may advantageously be utilized in any means of transportation, e.g. a car, train, airplane, ship, spacecraft, etc., e.g. for control of the means of transportation.

Below the invention will be described in more detail with reference to the exemplary embodiments illustrated in the drawing, wherein

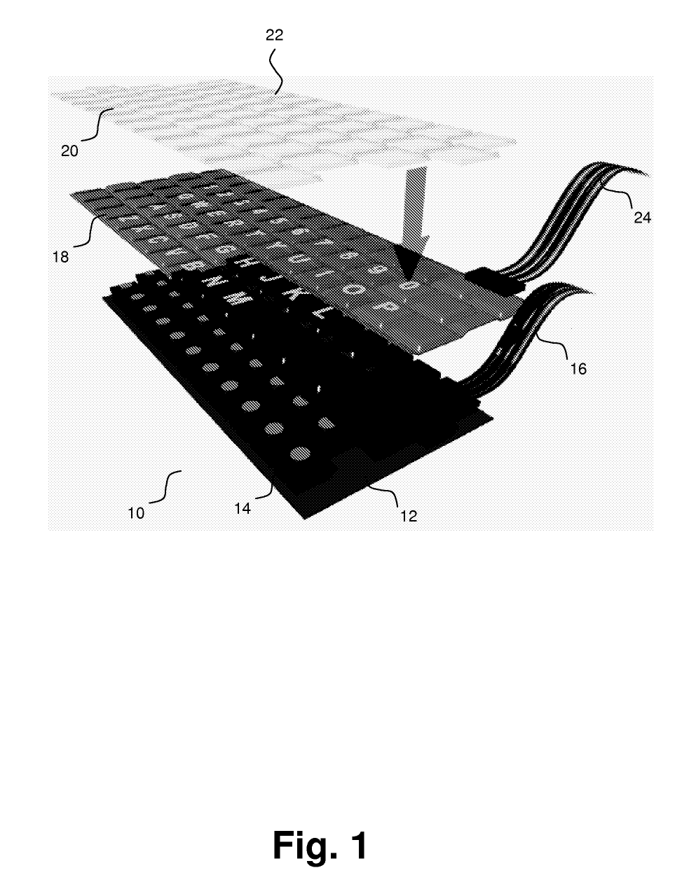

FIG. 1 shows schematically an exploded view of a keyboard according to the present invention,

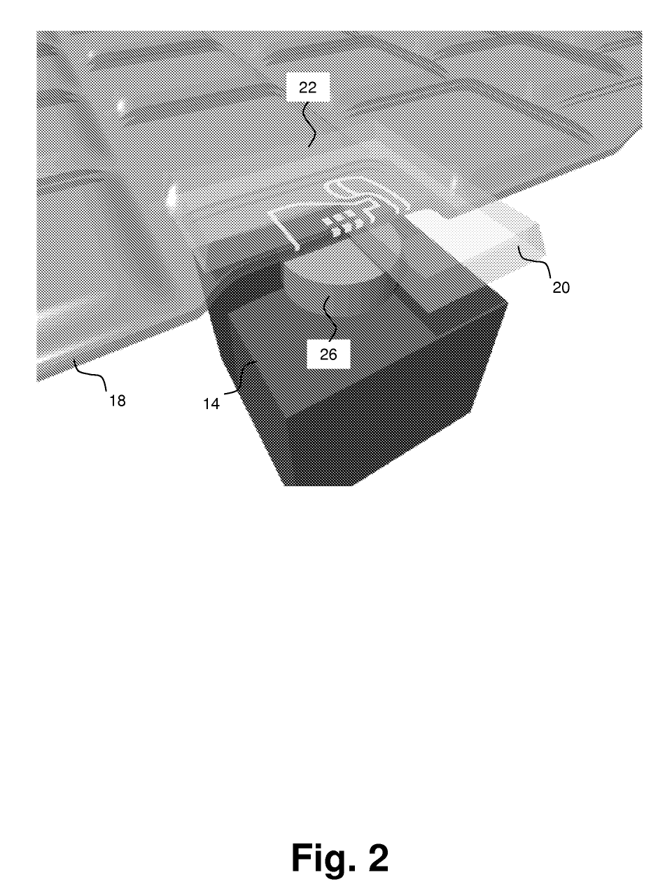

FIG. 2 shows a detail of the keyboard shown in FIG. 1,

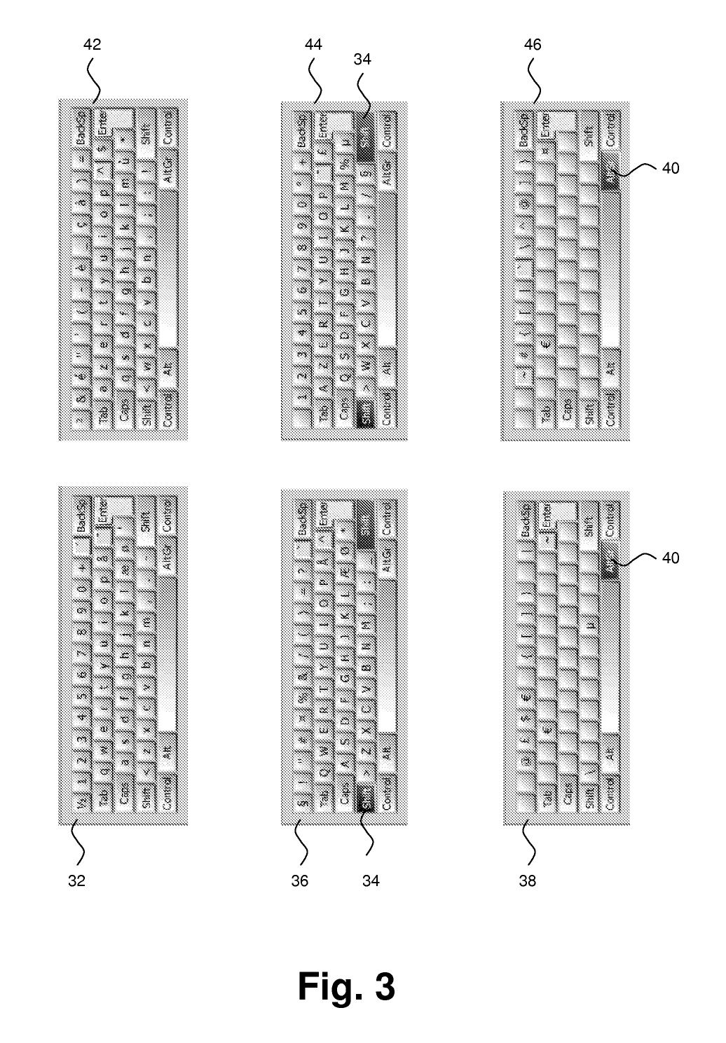

FIG. 3 illustrates various uses of the keyboard shown in FIG. 1,

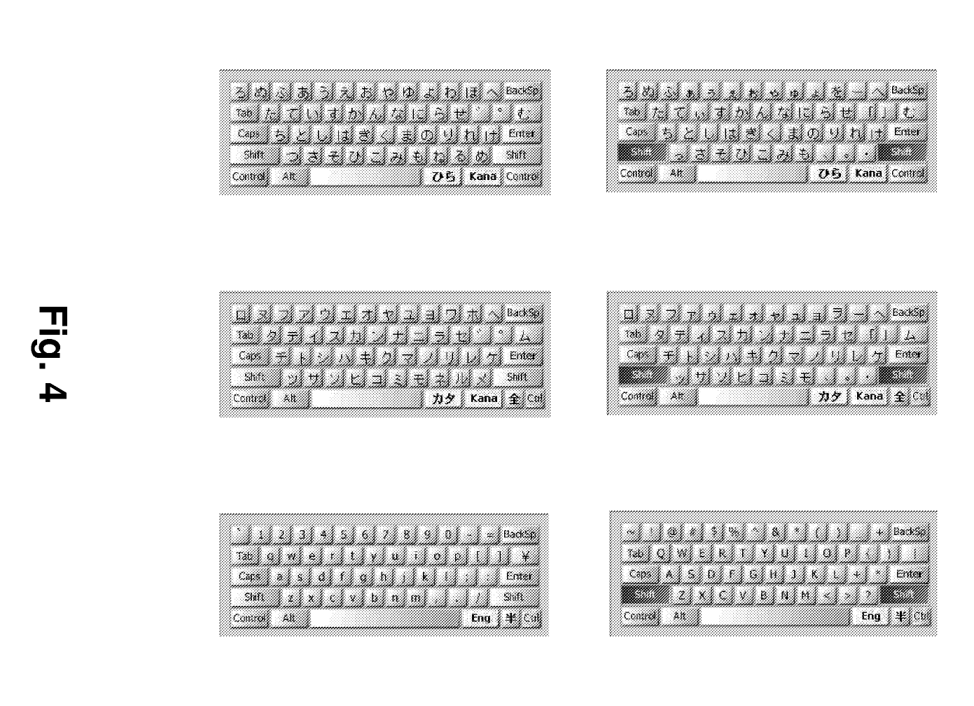

FIG. 4 illustrates further uses of the keyboard shown in FIG. 1,

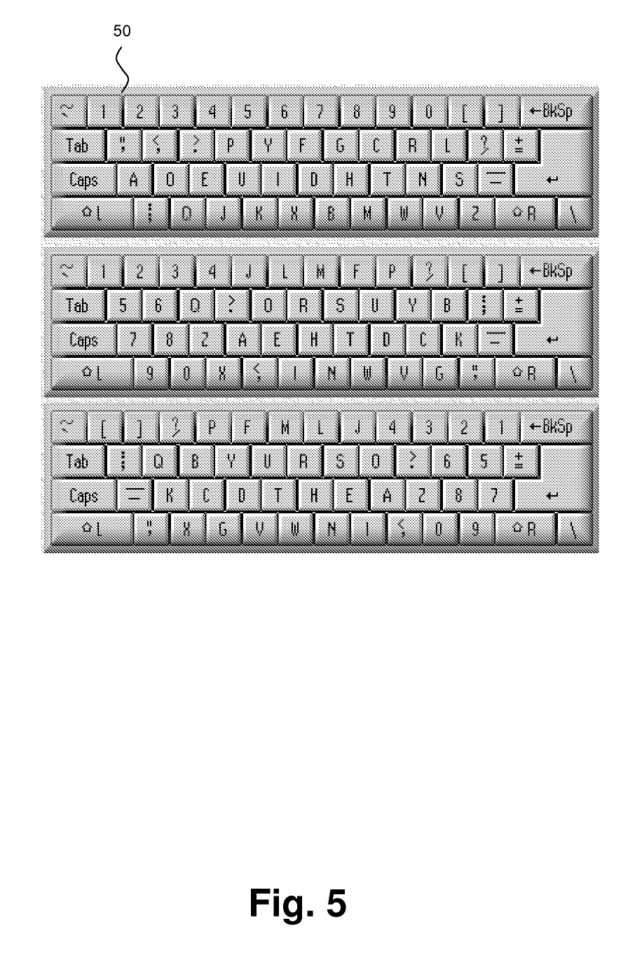

FIG. 5 illustrates still further uses of the keyboard shown in FIG. 1.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

FIG. 1 shows an exploded view of the basic components of a keyboard 10 according to the present invention. The illustrated keyboard 10 comprises a printed circuit board 12 with key switches 14 arranged in a conventional computer keyboard array with five rows of key switches 14. Signal lines 16 are used to scan the key switches 14 to detect depressed key switches 14 as is well-known in the art. A flexible display 18 constituting upper parts of the keys is pre-shaped to fit on top of the key switches 14 and underneath the key caps 20. The top surfaces 22 of the key caps 20 are transparent so that the user can view the displayed key labels through the respective transparent key caps 20. Signal lines 24 are used to control the display 18.

FIG. 2 illustrates in more detail one of the key switches 14 and the display 18 displaying a telephone symbol in the label of the key which label can be viewed through the transparent top surface 22 of the key cap 20.

In the illustrated embodiment, each key has a flat top surface that does not change its flat shape when the key is depressed similar to a conventional keyboard with individually depressible keys.

Each key switch 14 of the illustrated embodiment has a substantially non-flexible member 26 with a contact element (not visible). The non-flexible member 26 is arranged to be displaced when the corresponding key is depressed until contact between the contact element and an electric circuit of the keyboard is established. Contact is detected by a control circuit of the keyboard. The non-flexible member of the illustrated embodiment is biased with a coil spring in a way well-known from conventional keyboards.

The linear displacement of the keys preferably ranges from 1 mm to 5 mm, such as from 2 mm to 5 mm, for example app. 3.5 mm.

In this way, the tactile feed-back provided by the keyboard during use corresponds to the tactile feed-back well-known by the user from use of high quality conventional keyboards, for example in connection with a computer. Conventional high quality keyboards do not include dome switches or membrane switches. Instead, the desired tactile feedback generally perceived by the user as an indication of high quality is provided by displaceable members biased by spring means.

In a keyboard according to the present invention, the bias force provided by the spring means may be adjusted to compensate for the resilience of the flexible display so that the resulting bias force of each key experienced by the user is substantially similar to a value that is well-known by the user from conventional high quality keyboards.

In FIG. 3, the lower row shows the keyboard according to the present invention used as a computer keyboard and displaying key labels in a way that corresponds to a conventional Danish computer keyboard. Image 32 shows the displayed lower case labels, including the Scandinavian vowels “ae”, “ø”, and “á”, when the “Shift”-key 34 is not depressed. Image 36 shows the displayed upper case labels when the “Shift”-key 34 is depressed and likewise, image 38 shows the displayed labels when the “AltGr”-key 40 is depressed.

It should be noted that the keyboard according to the present invention simplifies user operation since the labels currently displayed indicate the current function of the respective keys in a clear and unambiguous way as opposed to conventional keyboards having some keys with three selectable symbols so that the user has to remember which other keys to activate to select one of the symbols of the key in question.

The upper row of FIG. 3 shows the keyboard according to the present invention used as a computer keyboard and displaying key labels in a way that corresponds to a conventional French computer keyboard. Image 42 shows the displayed lower case labels when the “Shift”-key 34 is not depressed. Image 44 shows the displayed upper case labels when the “Shift”-key 34 is depressed and likewise, image 46 shows the displayed labels when the “AltGr”-key 40 is depressed.

It is an important advantage of the present invention that one keyboard may be manufactured for all languages. Also, a person visiting a foreign country to work there can easily change the layout of the keyboard into his or her usual layout.

To further illustrate the versatility of the keyboard according to the present invention, FIG. 4 shows the keyboard displaying various typical keyboard layouts as used in Japan.

FIG. 5 shows the keyboard according to the present invention displaying the standard Dvorak layout 50. The Dvorak layout facilitates easy and fast keying since the five most used vowels and consonants (in English) are positioned in the row forming the starting position of the fingers of the user. A corresponding layout in other languages is easily provided by the keyboard according to the present invention. The middle layout is a right hand Dvorak layout, and the lower layout is a left hand Dvorak layout.

1-21. (canceled)

22. A keyboard with a plurality of keys with key switches arranged in a conventional computer keyboard array and covered by a flexible display for displaying individual labels of the keys, the flexible display being pre-shaped into a non-planar shape to fit on top of the key switches so that each key switch is activated by depressing the area of the flexible display displaying the key label of the key switch in question, and wherein each key switch of the plurality of keys has a substantially non-flexible member with a contact element and wherein the non-flexible member is arranged to be displaced when the corresponding key is depressed until contact between the contact element and an electric circuit of the keyboard is established, the linear displacement of the keys ranging from 1 mm to 5 mm.

23. A keyboard according to claim 22, wherein each of the plurality of keys further has a key cap with a transparent top surface, and the flexible display is mounted underneath the key caps for displaying individual labels of the keys viewable through the transparent top surfaces of the respective key caps.

24. A keyboard according to claim 22, wherein the displaceable members are biased by spring means, and the bias force provided by the spring means is adjusted to compensate for the resilience of the flexible display so that the resulting bias force of each key experienced by the user is substantially similar to a value that is well-known by the user from conventional high quality keyboards.

25. A keyboard according to claim 22, wherein the display is an OLED display.

26. A keyboard according claim 22, wherein the display is an electrophoretic display.

27. A keyboard according to claim 22, wherein the display is an electro-wetting display.

28. A keyboard according to claim 22, wherein the display is a polymer LCD display.

29. An apparatus with a processor that is connected to a keyboard according to claim 22, and that is adapted to receive inputs from the keyboard and to control the display for displaying key labels in response to a user input.

30. An apparatus according to claim 29, wherein the processor is further adapted to control the flexible display to display a conventional layout of lower case letters, numbers and other characters used in writing in a selected country and to change the labels into corresponding upper case letters, numbers, and other characters.

31. An apparatus according to claim 30, wherein the layout is a Dvorak layout.

32. An apparatus according to claim 29, wherein the layout is a layout of an alphabet selected from the group consisting of the European, Japanese, Arabic, Russian, and Chinese alphabet.

33. An apparatus according to claim 29, wherein the processor is further adapted to control the display to display symbols indicating functions of functions keys executed by a software program upon activation of the respective key.

34. An apparatus according to claim 33, wherein the software program is selected from the group consisting of a word processor, a game, a spreadsheet, a database, a CAD/CAM program.

35. An apparatus according to claim 33, wherein the processor is further adapted to control the display to sequentially display certain key labels in a way that guides the user through a certain software program thereby eliminating the need of consulting a manual for the program.

36. An apparatus according to claim 29, wherein the processor is adapted to execute an editor that allows the user to define the keyboard layout.
